(19) United States
(12) Patent Application Publication
(10) Pub. No.: US 2008/0072019 A1
(43) Pub. Date: Mar. 20, 2008

(54) Technique to clear bogus instructions from a processor pipeline

(76) Inventors: Avinash Sodani, Portland, OR (US); Ranjani Iyer, Beaverton, OR (US); Sean Mirkes, Portland, OR (US); Sebastien Hily, Hillsboro, OR (US); David Koufaty, Portland, OR (US); Stephan Jourdan, Portland, OR (US); Zhongying Zhang, Portland, OR (US)

Correspondence Address: CAVEN & AGHEVLI;c/o INTELLEVATE, P.O. BOX 52050, MINNEAPOLIS, MN, 55402, US

(21) Appl. No.: 11/523,930

(22) Filed: Sep. 19, 2006

(51) Int. Cl. G06F 9/30

(52) U.S. Cl. 712/219; 712/226

(57) ABSTRACT

A technique to filter bogus instructions from a processor pipeline. At least one embodiment of the invention detects a bogus event, removes only instructions from the processor corresponding to the bogus event without affecting instructions not corresponding to the bogus event.

### BACKGROUND

1. Field

The present disclosure pertains to the field of computing and computer systems, and, more specifically, to the field of clearing bogus instructions from a processor pipeline.

2. Background

In some processor architectures, such as those that can perform out-of-order operations, instructions, or operations decoded from instructions (micro-operations, or “uops”), may be incorrectly issued or dispatched through the processor as a result of events, such as incorrectly predicted program branches. Similarly, an instruction clearing event, such as a “nuke” operation, may render instructions or uops (hereinafter referred to generically as “instructions”) existing within the processor prior to the clearing event invalid. Invalid instructions within a processor pipeline, or “bogus” instructions, may pose a potential problem if they are not properly cleared and/or prevented from affecting processor state or program order.

FIG. 1 illustrates a prior art processing architecture, in which instructions may propagate through a number of various pipeline stages concurrently with each other. In particular, FIG. 1 illustrates a decoder to decode instructions into smaller operations, such as uops. Some prior art processing architectures may not decode instructions into uops. The instructions (or uops, depending on the architecture) may, at a later stage, be scheduled for execution by a scheduler and/or reservation station. A re-order buffer (ROB) may store a record of the instructions decoded and written into the reservation station, such that information, such as program order (which may be different from dispatch order), are maintained as long as the instructions are being processed within the pipeline. An execution engine may actually perform the operations prescribed by the instructions and indicate which instructions are to be executed next. After an instruction is executed, it may be retired by a retirement unit, which may be reflected in a field of the ROB corresponding to the retired instruction.

If an instruction being processed within the pipeline of FIG. 1 is determined to be bogus, for various reasons, the instruction may need to be cleared from the pipeline and prevented from affecting processing of other instructions. Some processing architectures may wait until any bogus instructions have been retired before processing further instructions. Other processing architectures may simply clear the processing pipeline of any instructions being processed and then allow correct instructions to be processed.

Prior art techniques to handle bogus instructions being processed within a processor architecture may cause unacceptable delays in processing non-bogus instructions, particularly if the techniques involve waiting for all bogus instructions to be retired before processing correct instructions. Processing architectures capable of processing instructions from more than one thread of instructions concurrently may also suffer from prior art bogus instruction handling techniques, particularly if the techniques involve clearing all instructions from the processor pipeline before allowing correct instructions to be issued. Clearing all instructions from a processor pipeline may clear both bogus instructions, from one thread, and non-bogus instructions from another thread, thereby causing the non-bogus instructions to be re-processed.

As a result, many techniques used to handle bogus processed within a processor may cause performance degradation within the processor or system in which the processor is used. Furthermore, many of these techniques can cause excessive power to be consumed during the handling of the bogus instructions.

### BRIEF DESCRIPTION OF THE FIGURES

The present invention is illustrated by way of example and not limitation in the accompanying figures.

FIG. 1 illustrates a prior art processor pipeline.

FIG. 2 illustrates a processor pipeline according to one embodiment of the invention.

FIG. 3 illustrates a re-order buffer (ROB), which may be used in one embodiment of the invention.

FIG. 4 is a flow diagram illustrating operations that may be performed in one embodiment of the invention.

FIG. 5 illustrates a shared-bus computer system, in which at least one embodiment of the invention may be used.

FIG. 6 illustrates a point-to-point bus computer system, in which at least one embodiment of the invention may be used.

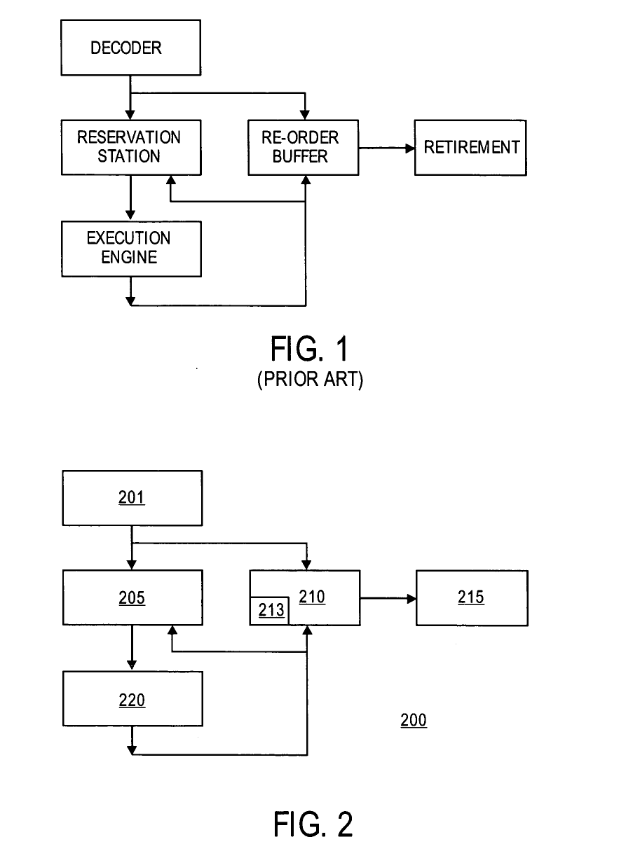

### DETAILED DESCRIPTION

Embodiments of the invention relate to computer systems. More particularly, at least one embodiment of the invention relates to a technique to remove bogus instructions from an instruction pipeline without significantly delaying processing of non-bogus instructions. At least one embodiment involves clearing bogus instructions or their records from processing logic, such as reservation stations, ROBs, load or store buffers, schedulers, etc., and filtering instructions within the processor that may be bogus without affecting non-bogus instructions.

In one embodiment, bogus instructions are selectively cleared from the processing pipeline, resulting from events, such as branch mispredictions or nukes, without affecting other correct instructions, such as those from other threads. Selectively clearing the bogus uops from the pipeline rather than waiting for all instructions to retire or clearing all instructions from the pipeline without regard to whether they are bogus, as in the prior art, may help to improve processor performance, in some embodiments, by removing the bogus instructions from the pipeline as soon as possible while allowing the non-bogus instructions to continue to be processed.

In one embodiment, bogus instructions are cleared from a processor pipeline in two ways: reclaiming processor resources that have been allocated to bogus instructions and/or by identifying bogus instructions within the processor and filtering these bogus instructions out of the processor pipeline without affecting non-bogus instructions within the pipeline. FIG. 2 illustrates a processing pipeline in which at least one embodiment of the invention may be used.

In particular, FIG. 2 illustrates a processing pipeline in a processor 200 having a decoding stage 201 to decode instructions, a reservation station (RS) 205 to schedule the decoded instructions for execution and temporarily store the instructions, a ROB 210 to store the scheduled instructions in a queue and to store various information pertaining to a program order of the instructions and/or information pertaining to resources used by the instructions. In one embodiment, the ROB may store the instructions in an order in which they appear in a program order after being executed by execution engine 215 out of program order. After the instructions are executed, a retirement unit 220 may cause resources used by the completed instructions to be released so that they can be used by other instructions. For example, in one embodiment, the retirement unit may enable entries within ROB, load and/or store buffer entries to be reallocated to other instructions. Logic 213 may be used to implement at least one embodiment of the invention. In some embodiments, the logic 213 consists of hardware circuits, whereas in other embodiments the logic consists of software. In other embodiments, the logic 213 may be a combination of software and hardware.

After an event, such as a branch misprediction or nuke operation, resources used by bogus instructions causing or resulting from the event may be reclaimed. For example, in one embodiment, a pointer (“ROBid”) corresponding to a ROB entry containing a bogus instruction from a mispredicted branch may be reset to point to a ROB entry corresponding to an instruction following the ROB entry corresponding to the mispredicted branch. Similarly, pointers corresponding to load and/or store buffer entries may be reset after a mispredicted branch occurs to point to an entry following an entry corresponding to the mispredicted branch. In one embodiment, the load and/or store buffer entry pointer is stored in a storage area, such as in the RS, for each instruction, such that the proper entry pointer, corresponding to an instruction in the load or store buffer following the bogus instruction, can be retrieved. Entries within the RS corresponding to a bogus instruction may also be invalidated. However, in one embodiment, the RS entries may not be sequentially allocated. Therefore, ROBid's stored in the RS entries may need to be compared to the ROBid corresponding to the instruction causing the event (such as mispredicted branch) to determine whether the RS entries are younger than the ROBid corresponding to the branch causing instructions to become bogus. If so, then the corresponding RS entry is invalidated, otherwise it is not.

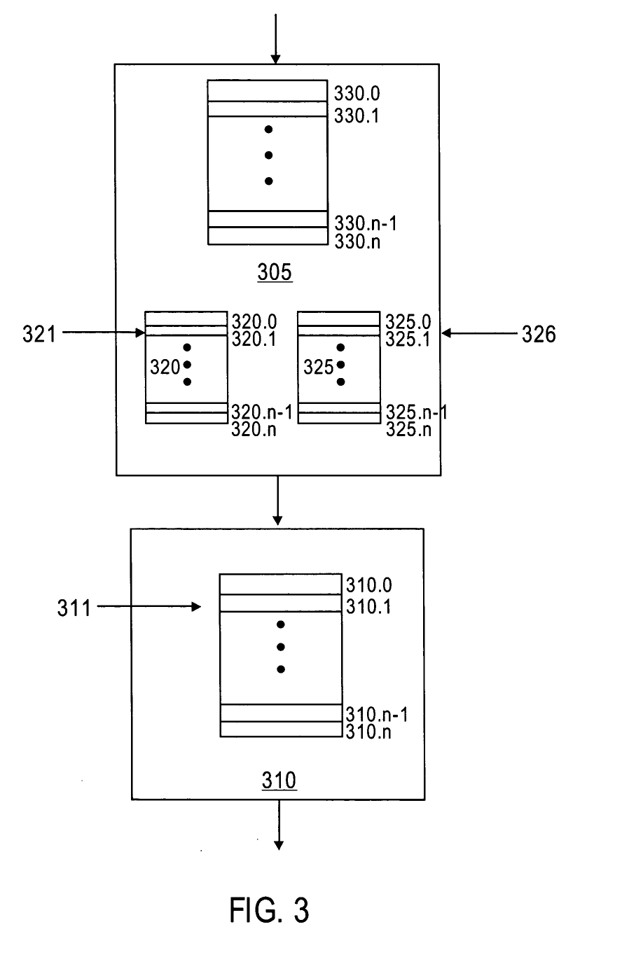

FIG. 3 illustrates various resources that may need to be reclaimed when recovering from a bogus instruction in a processor pipeline, according to one embodiment. Particularly, FIG. 3 illustrates a ROB 310 including a number of entries 310.1-310.n, where ‘n’ is a variable. In one embodiment, records of instructions in the processor are stored from the ‘top’ of the ROB to the ‘bottom’ in a first-in-first-out fashion, wherein the most recent records are stored in the higher numbered entries. Pointer 311 stores a ROBid corresponding to the entry of the ROB containing the most recently stored instruction information. In one embodiment, if the entry 310.1 corresponds to an event (such as a mispredicted branch), the pointer is incremented by one, such that it points to the next entry 310.2 (not explicitly shown), which is presumed to not be bogus, since after all bogus instructions are cleared, the new non-bogus instructions would start writing the ROB starting 310.2.

FIG. 3 also illustrates a load buffer 320 and store buffer 325 each having a number of entries 320.0-320.n, 325.0-325.n, where ‘n’ is variable. In one embodiment, the load and store buffers are located within the RS 305, whereas in other embodiments they may be located outside of the RS. The load buffer and store buffer each have an associated pointer 321, 326, respectively to point to the load or store most recently allocated for execution. Similar to the ROB, if entries 320.1 or 325.1 contain information corresponding to a bogus structure, then the appropriate pointer is incremented by one to point to the following entry 320.2, 325.2 (not explicitly shown), which is presumed to not be bogus, since after all bogus instructions are cleared, the new non-bogus loads or stores would start writing the appropriate buffers starting 320.2 or 325.2, respectively.

The RS also stores entries 330.0-330.n, where ‘n’ is variable, to store information corresponding to instructions which may or may not be sequential. In one embodiment each RS entry 330.0-330.n stores a ROBid corresponding an instruction stored in the ROB. Therefore, in one embodiment, if an event, such as a mispredicted branch, occurs, the ROBid corresponding to the mispredicted branch may be compared to the ROBid's stored in the RS, such that if a stored ROBid is greater than the ROBid of the eventing instruction then the corresponding RS entry may be invalidated. A ROBid of an instruction being greater than the ROBid of an eventing instruction indicates that the instruction is younger than the eventing uop, in one embodiment, and hence is bogus. The invalidated RS entry may be reused by new non-bogus instructions after the bogus instructions are cleared.

In other embodiments, other resources in addition to or in lieu of those described above may be reclaimed as a result of a bogus instruction being present within a processor pipeline. Furthermore, bogus instructions may result from other events, besides mispredicted branches or nuke operations.

In order to prevent instructions that may be in a processor pipeline (“long latency” instructions) from storing information into resources, such as the ROB or RS, after new information from new instructions have been stored in these resources, at least one embodiment of the invention uses a filtering technique to detect and remove long latency instructions from the pipeline. One example of a long latency instruction may be an instruction, such as a load instruction, that attempts to access a cache, misses, and must wait for data to return from a longer-latency memory structure, such as DRAM. After this instruction has received data from memory, it may then attempt to store the data into a resource, such as a ROB or RS, and possibly over-writing more recent information from more recent instructions. Over-writing data from more recent instructions with data from an instruction that has been determined to be bogus may cause undesired results in the processor and in a user's program.

In one embodiment, a bogus instruction filtering technique may be used that is dependent upon an amount of time (e.g., processor cycles) between the point a bogus instruction is detected and the point at which a new non-bogus instruction will use resources, such as the ROB, RS, load and store buffers, etc. In one embodiment, an amount of time between detection of a bogus instruction and when a non-bogus instruction will make use of processor resources may be a deadline, before which any bogus instruction must complete any operations that use these processor resources. Otherwise, a bogus instruction may over-write information stored in processor resources by non-bogus instructions.

In one embodiment, logic (either software, hardware, or a combination thereof) may be used to filter instructions at various points in a processor pipeline, such as paths through which long-latency instructions typically pass. For example, in one embodiment, one or more filters may be implemented within the RS, the ROB, or in other processor resources that long-latency instructions may attempt to access.

In the case of a bogus instruction corresponding to mispredicted branch, bogus instructions may be detected by a filter performing a comparison of the ROBid's of the mispredicted branch and other instructions in the pipeline detected by the filter. For example, in one embodiment, in which a bogus instruction is generated due to a mispredicted branch, if the ROBid of the other instructions detected by the filter is greater than that of the mispredicted branch, it may be assumed that the other instruction is younger than the mispredicted branch, and therefore bogus too. However, if the ROBid of the other instructions detected by the filter is less than the ROBid of the mispredicted branch, it may be assumed that the other instructions are older and therefore not bogus, and therefore should not be removed from the pipeline. This or other techniques may be used for detected bogus instructions from other events, such as nuke operations.

In order to provide a clearer understanding of how some embodiments of the invention may be performed, three scenarios are illustrated below involving three separate bogus instructions, uops, or the like. The examples provided below are merely to illustrate how one or embodiments of the invention may be used to recover resources used by bogus instructions and clear the bogus instructions from a processor pipeline without affecting the processing of non-bogus instructions. In other examples, other instructions, numbers of processing cycles, or events may be used in conjunction with one or more embodiments of the invention.

The tables below illustrate the relative order and timing of various operations taking place within a microprocessor, in which at least one embodiment may be used. Table 1, for example, illustrates the occurrence of a mis-predicted branch resulting in a bogus add instruction being proliferated through a processor pipeline in which a newer non-bogus instruction may be processed. Particularly, Table 1 illustrates a misprediction occurring at processor cycle 4, resulting in clearing of processor resources, such as the RS, ROB, etc., at cycle 6. Coincidentally, a bogus add instruction resulting from the misprediction is scheduled at cycle 6 and writes back information to the ROB (e.g., to indicate the completion of the add instruction) at cycle 10. In the particular example illustrated in Table 1, the minimum time from the point of the misprediction (cycle 4) in which a newer non-bogus instruction may be scheduled is cycle 12, which in this case writes back information to the ROB at cycle 14. In other embodiments, non-bogus instructions may be scheduled after a misprediction sooner or later than illustrated in Table 1.

Because, in the example illustrated in Table 1, the minimum point from the misprediction at which a newer non-bogus instruction may write-back to the ROB is cycle 14 (i.e., after the last bogus instruction resulting from the misprediction writes back information to the ROB), no filtering of bogus instructions is necessary. All bogus instructions will have written back the ROB before the earliest non-bogus instruction following the misprediction will write back the ROB.

TABLE 1

| | | | | | | | | | | | | | |
|---|---|---|---|---|---|---|---|---|---|---|---|---|---|
| 1 | 2 | 3 | 4 | 5 | 6 | 7 | 8 | 9 | 10 | 11 | 12 | 13 | 14 |

8 clocks

| | | |
|---|---|---|
| Mispred.Propogate Clear | New Uops | ROB |
| | @ Alloc | write |

| Latest dispatch of Add | | | | |
|---|---|---|---|---|
| Rdy/Schd | Read | Byp | Exec | ROB WB |

Table 2 illustrates a situation in which all bogus instructions caused by an event, such as a misprediction, do not write back to the ROB before an earliest non-bogus instruction writes back to the ROB. The example illustrated in Table 2 includes a bogus multiply instruction scheduled at processor cycle 6 as a result of an event, such as a misprediction, at cycle 4. Resources, such as the ROB, RS, etc., may be cleared at cycle 6 as the bogus multiply instruction is scheduled. In one embodiment, the bogus multiply instruction may not write back to the ROB (e.g., to indicate the multiply instruction's completion) until cycle 14, which happens to be, in this example, the same clock cycle in which newer non-bogus instruction, issued at a minimum time after the misprediction (cycle 12 in this case), writes back to the ROB. If allowed to proceed, the bogus information written back to the ROB may overwrite the newer non-bogus information written to the ROB, thereby storing incorrect information in the ROB.

Therefore, in one embodiment, a filter may be used to compare the ROBid of an instruction that caused an event, such as a misprediction or nuke, with the ROBid of other subsequently scheduled instructions, such as the bogus multiply instruction, in order to determine which one is younger and therefore whether the bogus multiply instruction should be cleared from the pipeline. Conversely, a filter may determine, through a comparison of ROBid's, that an instruction is actually older than (i.e., decoded before) an instruction that caused the misprediction, nuke, etc., and therefore allow that instruction to writeback to the ROB, since resources such as RS entry, ROB entry, etc. allocated to that instruction would not have been cleared in cycle 6 and hence any newer non-bogus instructions will not reuse those resources and therefore not conflict for them.

In the embodiment illustrated in Table 2, a filter, which may be software, hardware, or some combination thereof, detects instruction ROBid's at point in the pipeline where bogus instructions may traverse, such as a multiplier circuit port, for example. In other embodiments, the filter may detect instruction ROBid's at other points in the pipeline, depending upon where bogus instructions may be propagated. In one embodiment, the filter detects ROBid's during cycle 9, in which the bogus instruction of Table 2 is actually executed. In other embodiments, the filter may detect ROBid's at other cycles between the time a misprediction or other event occurs and when a bogus instruction may actually writeback to the ROB.

TABLE 2

| 1 | 2 | 3 | 4 | 5 | 6 | 7 | 8 | 9 | 10 | 11 | 12 | 13 | 14 |
|---|---|---|---|---|---|---|---|---|---|---|---|---|---|
| | | | | 8 clocks | | | | | | | | | |
| | | Mispred.Propogat clear | | | | | | | | | New Uops | | ROB |
| | | | | | | | | | | | @ Alloc | | write |
| | | | | | Latest dispatch of | | | | | | | | |
| | | | | | Multiply | | | | | | | | |
| | | | | | Rdy/Schd | Read | Byp | Exec | | | | WB | ROB WB |

Filter

In some embodiments, writebacks to the ROB from some instructions may need to be arbitrated. For example, Table 3 illustrates processing of two divide instructions scheduled as a result of an event, such as a misprediction: a first divide instruction that is scheduled at cycle 6, and a second divide instruction scheduled sometime before cycle 6.

In one embodiment, the RS stores the ROBid of a divide operation being processed. Logic performing the divide operation, such as the execution unit, may notify the RS of when a ROB writeback for that divide operation will occur. The RS may use the notification to notify the ROB of the divide's ROBid. In order to prevent a divide operation from writing back to the ROB, the divide operation's ROBid may be cleared from the RS.

TABLE 3

| | | | | | | | | | | | | | |
|---|---|---|---|---|---|---|---|---|---|---|---|---|---|
| 1 | 2 | 3 | 4 | 5 | 6 | 7 | 8 | 9 | 10 | 11 | 12 | 13 | 14 |

8 clocks

| | | |
|---|---|---|
| Mispred Propogate RS clear | New Uops | ROB |
| | @ Alloc | write |

| Latest Div Sched | Rdy/Schd | Read | Byp | Exec | | |
|---|---|---|---|---|---|---|
| | | | | Divide's | Signal Clr | Divider |
| | | | | Pdst | Divider | Cleared |
| | | | | Cleared | | |

| | | | |
|---|---|---|---|
| Lateat Div WB | 3-cycle pdst | WB | ROB WB |
| w/o conflict | Divide's | | |

Pdst
Cleared

Table 3 illustrates a bogus divide instruction being scheduled at cycle 6. The bogus divide needs to be cleared from the pipeline, because its writeback may occur well after the new non-bogus instructions have started writing results in the ROB at cycle 14, and hence may potentially overwrite new non-bogus results. In one embodiment, the ROBid of the event-causing instruction is compared with ROBid's of instructions being issued from the RS (e.g., at the RS's inputs/outputs), and if the instructions issued from the RS are younger than the ROBid of the event-causing instruction, they are cleared from the pipeline.

Also illustrated in Table 3 is a situation, in which a bogus divide instruction is being processed when an event, such as a misprediction or nuke, occurs. In one embodiment, the bogus divide instruction issued before the event may not be allowed to writeback to the ROB after cycle 13, without conflicting with a non-bogus instruction. In one embodiment, the ROBid of a bogus divide may be broadcast to the RS and other pertinent logic some number of cycles prior to a writeback (e.g., in cycle 9) to the ROB by the bogus divide operation. Therefore, in one embodiment, to prevent any bogus writebacks from the bogus divide instruction after cycle 13, the ROBid broadcasts after cycle 9 may need to be suppressed. Therefore, cycle 9 is the latest cycle in which the bogus divide instruction's ROBid may appear in the RS.

For both scheduling a latest divide instruction (cycle 6 in Table 3) and a divide instruction being processed before the scheduling the latest divide instruction (before cycle 6 in Table 3), bogus divide instructions may be detected by comparing the divider's ROBid in the RS with the ROBid of the event-causing instruction, such as mispredicted branch (cycle 4). In one embodiment, if the bogus divide instruction's ROBid is younger than the mispredicted branch, then the bogus divide instruction's ROBid may be cleared from the RS, thereby preventing the bogus divide instruction from writing back the results of a bogus divide operation into the ROB. In the embodiment described above, a comparison may need to be performed before cycle 9 in order to prevent a ROB writeback corresponding to the bogus divide.

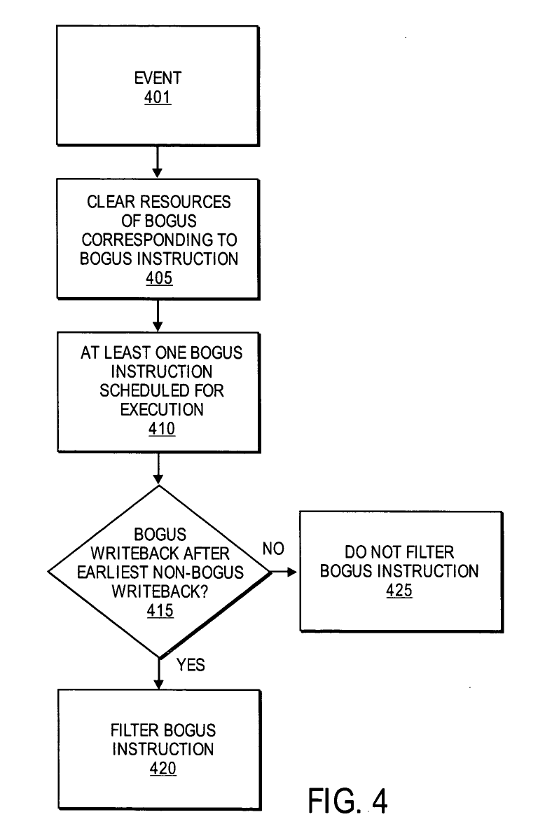

FIG. 4 is a flow diagram illustrating various operations that may be used in at least one embodiment of the invention. At operation 401, an event, such as a misprediction or nuke, occurs causing at least one bogus instruction to be scheduled for execution in a processor pipeline at operation 410. At operation 405 resources are cleared of information pertaining to bogus instructions caused by the event, including the RS, ROB, load/store buffers, etc. If at operation 415, a bogus instruction caused by the event may writeback information to a ROB after the earliest non-bogus instruction scheduled after the event writes back information to the ROB, then at operation 420, bogus instructions are filtered from the pipeline based on whether they have a ROBid that is younger than the ROBid of the instruction(s) causing the event. This process may be repeated until a new non-bogus instruction writes back information to the ROB.

In one embodiment, the operations above may be applied to bogus instructions that writeback information to the ROB before a new non-bogus instruction does, including, but not limited to, add instructions, multiply instructions, or divide instructions. Furthermore, operations discussed in reference to FIG. 4 may apply to instructions that have a fixed writeback latency or a variable latency. Accordingly, one or more embodiments of the invention may use operations described above to selectively choose which instructions to clear from the pipeline in response to a bogus operation, such as a misprediction or a nuke, without disturbing the processing of instructions that did not result from the bogus event.

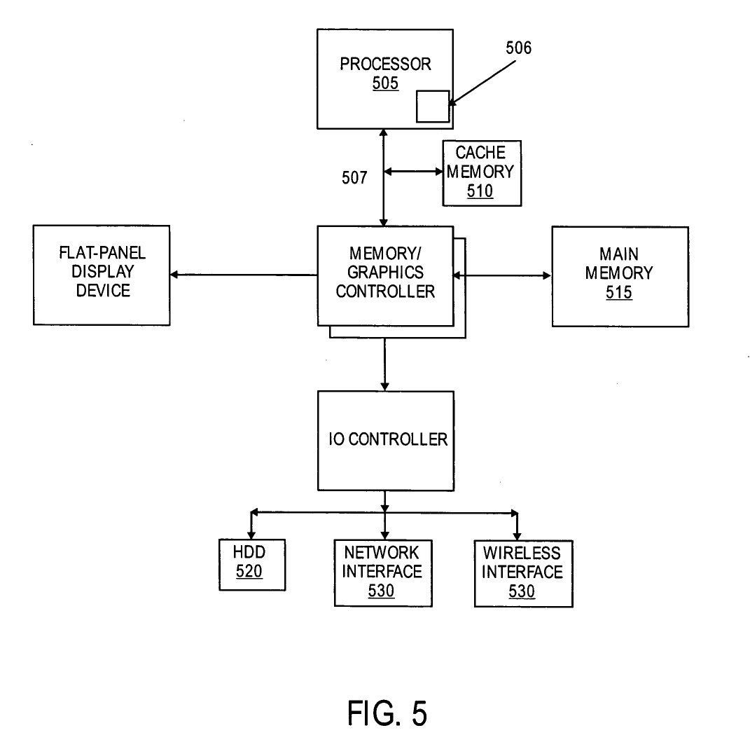

FIG. 5 illustrates a front-side-bus (FSB) computer system in which one embodiment of the invention may be used. A processor 505 accesses data from a level one (L1) cache memory 510 and main memory 515. In other embodiments of the invention, the cache memory may be a level two (L2) cache or other memory within a computer system memory hierarchy. Furthermore, in some embodiments, the computer system of FIG. 5 may contain both a L1 cache and an L2 cache.

The main memory may be implemented in various memory sources, such as dynamic random-access memory (DRAM), a hard disk drive (HDD) 520, or a memory source located remotely from the computer system via network interface 530 containing various storage devices and technologies. The cache memory may be located either within the processor or in close proximity to the processor, such as on the processor's local bus 507.

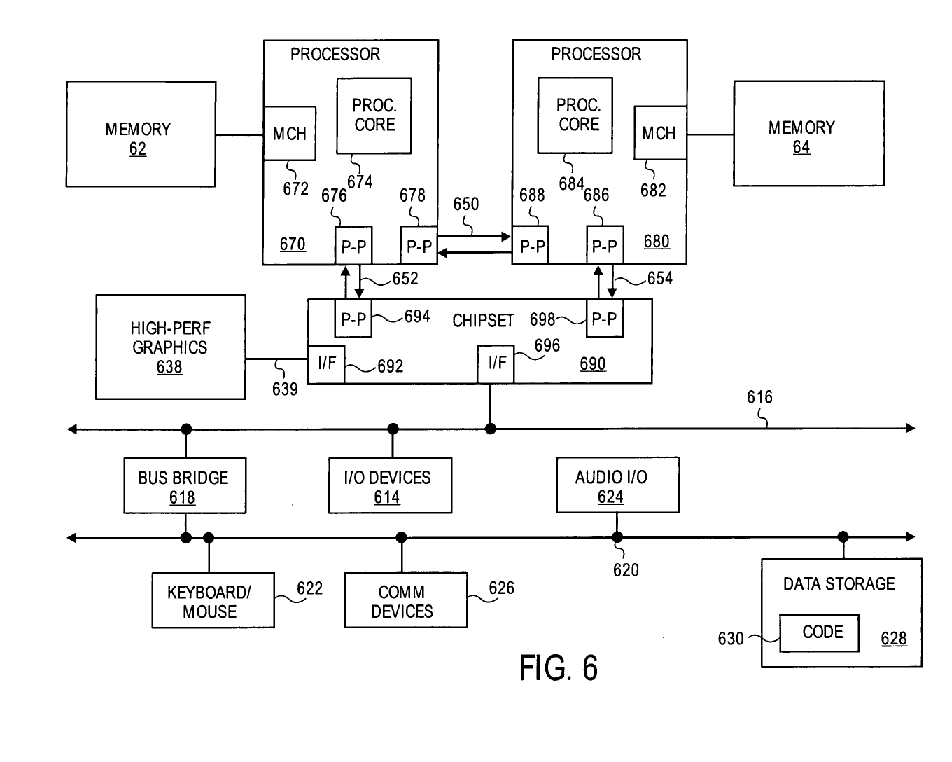

Furthermore, the cache memory may contain relatively fast memory cells, such as a six-transistor (6T) cell, or other memory cell of approximately equal or faster access speed. The computer system of FIG. 5 may be a point-to-point (PtP) network of bus agents, such as microprocessors, that communicate via bus signals dedicated to each agent on the PtP network. FIG. 6 illustrates a computer system that is arranged in a point-to-point (PtP) configuration. In particular, FIG. 6 shows a system where processors, memory, and input/output devices are interconnected by a number of point-to-point interfaces.

The system of FIG. 6 may also include several processors, of which only two, processors 670, 680 are shown for clarity. Processors 670, 680 may each include a local memory controller hub (MCH) 672, 682 to connect with memory 22, 24. Processors 670, 680 may exchange data via a point-to-point (PtP) interface 650 using PtP interface circuits 678, 688. Processors 670, 680 may each exchange data with a chipset 690 via individual PtP interfaces 652, 654 using point to point interface circuits 676, 694, 686, 698. Chipset 690 may also exchange data with a high-performance graphics circuit 638 via a high-performance graphics interface 639. Embodiments of the invention may be located within any processor having any number of processing cores, or within each of the PtP bus agents of FIG. 6.

Other embodiments of the invention, however, may exist in other circuits, logic units, or devices within the system of FIG. 6. Furthermore, in other embodiments of the invention may be distributed throughout several circuits, logic units, or devices illustrated in FIG. 6.

Processors referred to herein, or any other component designed according to an embodiment of the present invention, may be designed in various stages, from creation to simulation to fabrication. Data representing a design may represent the design in a number of manners. First, as is useful in simulations, the hardware may be represented using a hardware description language or another functional description language. Additionally or alternatively, a circuit level model with logic and/or transistor gates may be produced at some stages of the design process. Furthermore, most designs, at some stage, reach a level where they may be modeled with data representing the physical placement of various devices. In the case where conventional semiconductor fabrication techniques are used, the data representing the device placement model may be the data specifying the presence or absence of various features on different mask layers for masks used to produce an integrated circuit.

In any representation of the design, the data may be stored in any form of a machine-readable medium. An optical or electrical wave modulated or otherwise generated to transmit such information, a memory, or a magnetic or optical storage medium, such as a disc, may be the machine-readable medium. Any of these mediums may “carry” or “indicate” the design, or other information used in an embodiment of the present invention, such as the instructions in an error recovery routine. When an electrical carrier wave indicating or carrying the information is transmitted, to the extent that copying, buffering, or re-transmission of the electrical signal is performed, a new copy is made. Thus, the actions of a communication provider or a network provider may be making copies of an article, e.g., a carrier wave, embodying techniques of the present invention.

Thus, techniques for steering memory accesses, such as loads or stores are disclosed. While certain embodiments have been described, and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principles of the present disclosure or the scope of the accompanying claims.

Various aspects of one or more embodiments of the invention may be described, discussed, or otherwise referred to in an advertisement for a processor or computer system in which one or more embodiments of the invention may be used. Such advertisements may include, but are not limited to news print, magazines, billboards, or other paper or otherwise tangible media. In particular, various aspects of one or more embodiments of the invention may be advertised on the internet via websites, “pop-up” advertisements, or other web-based media, whether or not a server hosting the program to generate the website or pop-up is located in the United States of America or its territories.

What is claimed is:

1. An apparatus comprising:
a processor pipeline to perform a plurality of instructions concurrently;
a first logic to clear only all bogus instructions of the plurality of instructions from the processor pipeline without preventing non-bogus instructions of the plurality of instructions from being performed.

2. The apparatus of claim 1, wherein at least one of the bogus instructions are to result from a mispredicted branch.

3. The apparatus of claim 1, wherein at least one of the bogus instructions are to result from a nuke event.

4. The apparatus of claim 1, wherein the processor pipeline includes a reservation station (RS) and a re-order buffer (ROB) to store a plurality of ROB identification fields (ROBid's) corresponding to the plurality of instructions.

5. The apparatus of claim 4, further comprising a comparison logic to compare a bogus event ROBid to at least one ROBid corresponding to at least one of the plurality of instructions.

6. The apparatus of claim 5, wherein the at least one of the plurality of instructions is to be cleared from the processor pipeline if its ROBid is younger than that of the bogus event.

7. The apparatus of claim 6, wherein the at least one ROBid corresponds to an instruction that is to writeback information to the ROB after a new non-bogus instruction is scheduled.

8. The apparatus of claim 7, wherein the new non-bogus instruction is the earliest non-bogus instruction that can be scheduled for execution following the bogus event occurs.

9. A system comprising:
a memory to store a plurality of instructions corresponding to a plurality of threads;
a processor to process a bogus instruction and a non-bogus instruction, each corresponding to a different thread, wherein only information corresponding to the bogus instruction is to be cleared from the processor without affecting the processing of the non-bogus instruction.

10. The system of claim 9, wherein the bogus instruction is to result from an event including either a mispredicted branch or a nuke event.

11. The system of claim 10, wherein if the bogus instruction is to writeback information to a re-order buffer (ROB) after a minimum amount of processing cycles, then an event ROB identifier (ROBid) corresponding to the event is compared to a bogus ROBid corresponding to the bogus instruction.

12. The system of claim 11, wherein if the comparison indicates that the bogus instruction is younger than an instruction corresponding to the event, the bogus instruction is to be cleared from the processor.

13. The system of claim 12, wherein the minimum amount of processing cycles corresponds to a processing cycle in which a first non-bogus instruction is to writeback information to the ROB following the event.

14. The system of claim 13, wherein the comparison is to be made by logic associated with an input/output (I/O) of a reservation station within the processor.

15. The system of claim 14, wherein the bogus instruction corresponds to an add operation.

16. The system of claim 14, wherein the bogus instruction corresponds to a multiply operation.

17. The system of claim 14, wherein the bogus instruction corresponds to a divide operation.

18. A method comprising:
mispredicting a branch within a program;
scheduling for execution at least one bogus instruction as a result of mispredicting the branch;
scheduling for execution at least one non-bogus instruction;
preventing the at least one bogus instruction from over-writing writeback information in a re-order buffer (ROB) corresponding to the non-bogus instruction.

19. The method of claim 18, further comprising clearing the non-bogus instruction from the ROB.

20. The method of claim 19, further comprising filtering other instructions that are to over-write writeback information corresponding to the non-bogus instruction.

21. The method of claim 20, wherein the filtering includes comparing a ROB entry identifier (ROBid) corresponding to the mispredicted branch with those corresponding to the other instructions.

22. The method of claim 21, wherein if the comparison indicates that the other instructions are younger than the mispredicted branch, then preventing the other instructions from performing their corresponding writebacks to the ROB.

23. The method of claim 22, wherein the bogus instruction includes an add operation.

24. The method of claim 22, wherein the bogus instruction includes a multiply operation.

25. The method of claim 22, wherein the bogus instruction includes a divide operation.

26. A processor comprising:
a decoder to decode a bogus instruction and a non-bogus instruction into a first and second micro-operation (uop), respectively;
a reservation station (RS) to schedule the first and second uop for execution;
a re-order buffer (ROB) to store a first and second information corresponding to the first and second uop, respectively, in a first-in-first-out manner;
a first logic to clear only the first uop from the RS and the ROB;
a second logic to prevent the first uop from over-writing writeback information in the ROB corresponding the second uop.

27. The processor of claim 26, wherein the second logic is to compare a bogus ROB entry identifier (ROBid) corresponding to the first uop with an event ROBid corresponding to an event uop causing the first uop to be scheduled for execution.

28. The processor of claim 27, wherein if the bogus ROBid is younger than the event ROBid, the first uop is to be prevented from overwriting writeback information within the ROB corresponding to the second uop.

29. The processor of claim 28, wherein the first uop is chosen from a group consisting of: an add uop, a multiply uop, and a divide uop.

30. The processor of claim 29, wherein the first and second uops are able to processed out of a program order.
